(19) United States
(12) Patent Application Publication
(10) Pub. No.: US 2009/0229094 A1
(43) Pub. Date: Sep. 17, 2009

(54) Retaining Clip for Hinged Windshield Assembly and Method for Manufacturing Same

(76) Inventor: William Victor Reese, Thomson, GA (US)

Correspondence Address: MYERS BIGEL SIBLEY & SAJOVEC, PO BOX 37428, RALEIGH, NC, 27627, US

(21) Appl. No.: 12/045,756

(22) Filed: Mar. 11, 2008

(51) Int. Cl. A44B 21/00; B60J 1/06

(52) U.S. Cl. 24/530; 296/96.2

(57) ABSTRACT

A retaining clip for the windshield of a wheeled vehicle includes: a windshield clip portion formed of a first material, the windshield clip portion including an inner wall, an outer wall, and a bridge connecting ends of the inner and outer wall to form a windshield clip channel sized to receive the side edge of a windshield panel; and a frame clip portion formed of a second material that differs from the first material, the frame clip portion including a joint arm mounted to the windshield clip inner wall, a retaining arm, and a bridge connecting ends of the joint arm and the retaining arm to form a frame clip channel. In this configuration, the windshield clip portion can easily and removably be attached to the windshield, and the frame clip portion can attach the windshield to the frame of the vehicle. In some embodiments, the retaining clip is co-extruded, with the windshield clip portion being formed in the same operation as the frame clip portion.

### FIELD OF THE INVENTION

The present invention relates generally to recreational vehicles such as golf cars or utility vehicles with releasably attached windshield assemblies, and more particularly to a holding device in a windshield assembly for releasably securing the windshield assembly to a recreational or utility vehicle.

### BACKGROUND OF THE INVENTION

Recreational vehicles, including golf cars, are often supplied with top coverings or canopies and windshield assemblies to protect occupants from foul weather, wind and sun. Many conventional recreational vehicles, such as golf cars, include a frame support system attached to the car body that includes front and rear vertical frame posts which support the top covering and windshield assembly. The windshield assembly is typically attached to the posts on the vehicle front and protects the occupants from wind and weather while moving.

Various types of windshield assemblies have been employed, including single and multi-panel windshields as well as windshields which open, are detachable or are fixed to the vehicle. Golf cars with windshield assemblies that open have been made in various forms. Many of these windshield assemblies include an upper panel that is hinged on its lower edge to a lower panel that is fixed to the vehicle. The upper panel is movable between a closed or raised position and an open or lowered position. In the closed position, the windshield panel is connected to the frame support posts, thereby blocking entry of wind or rain into the cab portion of the golf car. In the open position, the panel is lowered away from the golf car frame, thereby creating an opening for ventilation and the like.

Multi-panel windshields have been connected to the vehicle by various methods. One type of connection for multi-paneled windshield assemblies employs a pawl latch device. In this connection, a hole is drilled in the windshield and a clip is inserted into the hole in the windshield. The clip is turned and folded to hold the windshield in place on the frame. Such connections permit vibrational stresses, torques and other forces to be transferred to the windshield (which is in direct contact with the vehicle frame), which can cause cracking or tearing of the windshield. This type of damage can require frequent and costly replacement of the windshield. Noises such as squeaking and rattling of the windshield during movement of the car may also be significant problems in these previous designs.

Other multi-paneled and single panel windshield assemblies have utilized snap-on fasteners or clips to join the windshield assembly to the frame. One type of these snap-on clips is an elongated extruded PVC clip having a rigid, C-shaped gap. Examples of this connector are shown in U.S. Pat. No. 4,343,503 to Samuelson. These snap-on PVC clips are utilized by snapping the clip over the edge of the windshield and the golf car frame together in the C-shaped channel to hold the windshield in place.

These snap-on fittings also hold the windshield in direct contact with the golf car frame system, which can cause the windshield to tear and crack during movement of the car. These snap-on devices can also easily fall off during use, thereby allowing the windshield to fall off of the car. Over time, the material of these PVC snap-on clips can fail or crack, lessening the gripping and holding ability of these clips. Further, squeaking, rattling and other noises can be experienced with these clips.

Other windshield assemblies have been made utilizing retainers that are permanently attached to the vehicle frame. One type of windshield assembly uses a retainer screwed to the vehicle frame that grips the windshield by a clip. An example of this is shown in U.S. Pat. No. 5,385,380 to Heavner. The vehicle end user must drill a hole in the frame of the golf car to attach this retainer. Such retainers often loosely hold the windshield, allowing the windshield to slip and fall out of the retainer during use or flop open during movement of the golf car. Also, the windshield may move within the retainer and cause squeaking or the like.

Other windshield assemblies with retainers attached to the frame have used PVC snap-on clips in combination with other retainers to permanently affix the windshield assembly to the car and releasably grasp the windshield. They can experience similar problems as the types which screw to the car frame. One such system is discussed in U.S. Pat. No. 5,385,379 to Heavner.

Additionally, many of these windshield assemblies require tools for attachment by the end user. For instance, some of these windshields require the end user to drill holes or attach fasteners to the car frame or windshield with screw drivers or wrenches.

Finally, a clip proposed in U.S. Patent No. 5,791,720 proposes a clip that is adhered to the windshield, then clipped to the car frame. The clip is typically formed of a relatively resilient material (such as EDPM rubber) to enable it to deflect sufficiently to clip to the frame. However, in some instances it may be laborious to adhere the clip onto the windshield, and in the event the clip needs to be replaced, the replacement clip must be re-adhered to the windshield.

### SUMMARY OF THE INVENTION

As a first aspect, embodiments of the present invention are directed to a retaining clip for the windshield of a wheeled vehicle. The retaining clip comprises: a windshield clip portion formed of a first material, the windshield clip portion including an inner wall, an outer wall, and a bridge connecting ends of the inner and outer walls to form a windshield clip channel sized to receive the side edge of a windshield panel; and a frame clip portion formed of a second material that differs from the first material, the frame clip portion including a joint arm mounted to the windshield clip inner wall, a retaining arm, and a bridge connecting ends of the joint arm and the retaining arm to form a frame clip channel. In this configuration, the windshield clip portion can easily and removably be attached to the windshield, and the frame clip portion can attach the windshield to the frame of the vehicle.

As a second aspect, embodiments of the present invention are directed to a windshield assembly for a wheeled vehicle. The windshield assembly comprises a windshield panel having a side edge and a retaining clip. The retaining clip comprises: a windshield engaging portion formed of a first material, the windshield engaging portion engaging the side edge of the windshield panel; and a frame clip portion formed of a second material that differs from the first material. The frame clip portion includes a joint arm mounted to the windshield engaging portion, a retaining arm, and a bridge connecting ends of the joint arm and the retaining arm to form a frame clip channel.

As a third aspect, embodiments of the present invention are directed to a method of forming a retaining clip for a windshield assembly. The method comprises the steps of: providing an extrusion die having a first portion and a second portion; extruding a first polymeric material through a first portion of the extrusion die, the first portion of the extrusion die forming the first material into a windshield engaging portion; extruding a second elastomeric material through the second portion of the die, the second material being different than the first material, the second portion of the die forming the second material into a frame clip portion having a joint arm in contact with the windshield engaging portion, a retaining arm, and a bridge connecting ends of the joint arm and the retaining arm to form a frame clip channel; and allowing the first and second materials to freeze to form a retaining clip. A method employing these extrusion steps can simplify manufacturing of the clip significantly.

### BRIEF DESCRIPTION OF THE FIGURES

FIG. 1 is an environmental view of a recreational vehicle having a windshield assembly with a retaining clip according to embodiments of the present invention.

FIG. 2 is a perspective view of the windshield assembly of FIG. 1 showing the upper panel of the windshield assembly in transition from a raised position to a lowered position.

FIG. 3A is a perspective view of the retaining clip of FIG. 1.

FIG. 3B is a perspective view of the retaining clip of FIG. 3A being mounted on a windshield.

FIG. 4 is a section view of the retaining clip of FIG. 3 in a relaxed condition.

FIGS. 5A-5D are sequential views showing how the retaining clip of FIG. 3 can be deflected to attach the windshield assembly to the recreational vehicle.

### DETAILED DESCRIPTION OF EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity.

As used herein the expression “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

With further reference to the drawings, FIG. 1 illustrates a retaining clip, designated at 10, of a windshield assembly 15 according to embodiments of the invention releasably attached to the frame 17 of a golf car 20 or other recreational vehicle. As used herein, “recreational vehicle” is defined to include recreational vehicles such as golf cars and utility vehicles such as a vehicle manufactured by Kawasaki sold under the name Mule™. Generally the vehicle frame 17 is supported on front wheels 18 and rear wheels 19. The frame 17 includes a pair of spaced apart upright support posts 21 (only one post 21 is visible in FIG. 1). The upright support posts 21 define the front of the recreational vehicle 20.

The upright posts 21 of the recreational vehicle 20 shown in FIG. 1 are commonly secured in holes or on the sides of certain vehicle frames 17. Examples of this post frame configuration are found, for example, on some golf cars manufactured and sold under the name E-Z-GO®. Other recreational vehicles or golf cars 20 include a post configuration having generally U-shaped post frame. This U-shaped post frame includes a horizontal frame post attached between or integrally formed with the pair of spaced apart upright posts 21 for attachment of certain windshield assemblies. These U-shaped post frames are typically bolted on the side of the vehicle frame 17. Examples of such U-shaped post frames are found on some golf cars manufactured by Club Car, Yamaha, and Melex. As used herein, “spaced apart upright posts” refers to recreational vehicle post configurations including the U-shaped post frame described above, spaced apart separate posts attached to opposite sides of a recreational vehicle as described above, and any other recreational vehicle post configuration which includes at least two spaced upright posts attached in any manner to a recreational vehicle.

In the illustrated embodiment, the recreational vehicle frame 17 can also comprise a pair of rear upright posts 23 (only one post 23 is visible in FIG. 1). The upright posts 21, 23 support the covering or canopy 25 of the golf car 20 if present.

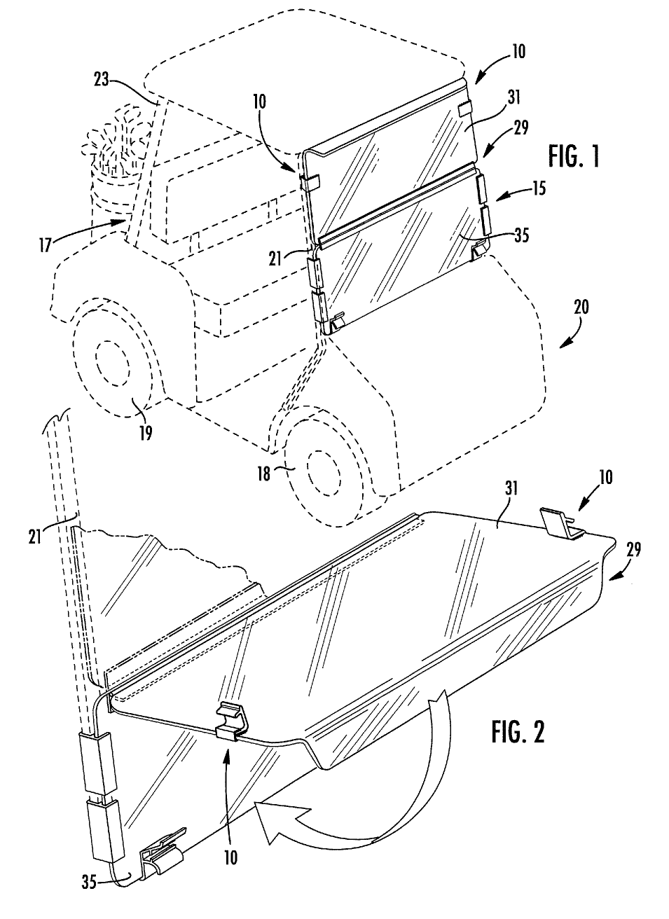

Various types of windshield assemblies, including both single-panel and multi-panel windshields, may be attached utilizing the retaining clip 10. In the embodiment shown in FIGS. 1 and 2, the windshield assembly 15 includes a multi-paneled windshield 29 comprising an upper panel 31 and a lower panel 35, with the upper panel 31 being pivotally connected with the lower panel 35 such that the upper panel 31 is movable between a raised or closed position and a lowered or open position. The closed position is shown in FIG. 1, with the upper panel 31 being connected to the front support post 21 by the retaining clip 10 such that the upper panel 31 is generally coplanar with the lower panel 35 and the side edge portions 32, 33 of the upper panel 31 overlie respective front support posts 21. In the lowered position, the upper panel 31 is inverted to overlie the lower panel 35. Construction and operation of the windshield assembly 30 is described in detail in U.S. Patent No. 5,791,720 to Moore et al., the disclosure of which is hereby incorporated herein by reference.

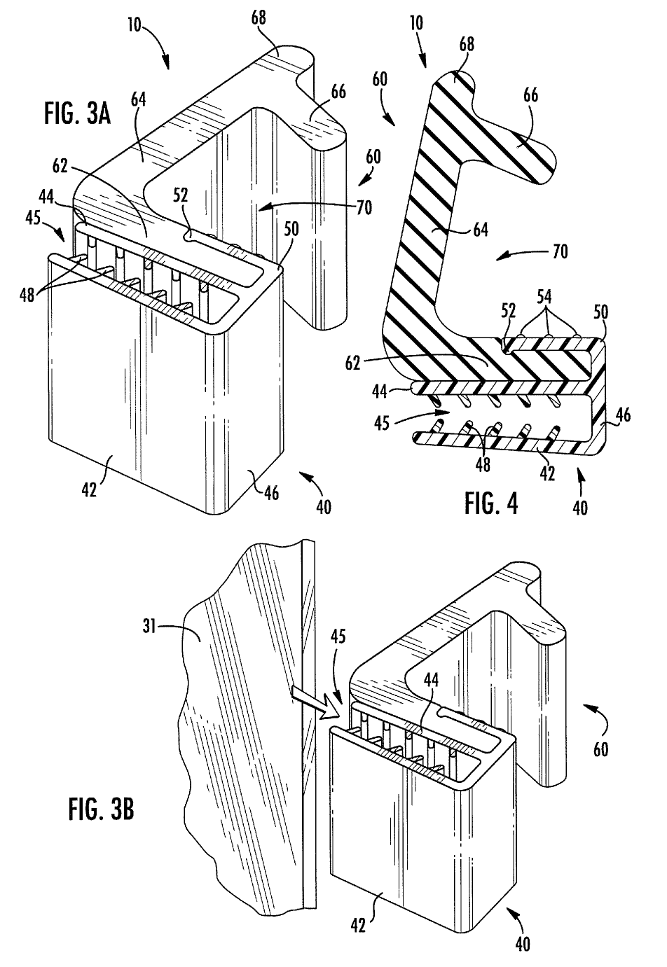

Turning now to FIGS. 3-5D, the retaining clip 10 includes a windshield clip portion 40 and a frame clip portion 60. The windshield clip portion 40 has an outer arm 42, an inner arm 44, and a bridge 46 that spans the ends of the outer and inner arms 42, 44, thereby forming a generally U-shaped channel 45. In some embodiments, the outer and inner arms 42, 44 are mounted to the bridge 46 such that the channel 45 tapers slightly with increasing distance from the bridge 46.

The windshield clip portion 40 also includes a generally L-shaped joint flange 50 that attaches to and is generally coplanar with the bridge 46 at the junction between the bridge 46 and the inner arm 44. The joint flange 50 has a nub 52 on its free end that protrudes toward the inner arm 44.

The windshield clip portion 40 may be formed of any material with sufficient resilience to enable the retaining clip 10 to mount on and remain fixed to the windshield assembly 15 in the manner described below. Exemplary materials include polymeric materials such as so-called “rigid PVC”, (i.e., PVC with an elastic modulus of at least 300,000 psi), rigid thermoplastic vulcanizates, spring steel, and the like.

Each of the outer and inner arms 42, 44 includes fingers 48 that extend into the channel while sloping away from the bridge 46. In some embodiments, the fingers 48 are formed of a different material than the outer and inner arms 42, 44. For example, if the outer and inner arms 42, 44 are formed of rigid PVC, the fingers 48 may be formed of so-called “flexible PVC”, which is considerable softer and more flexible than rigid PVC. Further, rub strips 54, which may be formed of the same material as the fingers 48, are positioned on the outer surface of the joint flange 50 facing away from the inner arm 44.

Referring still to FIGS. 3-5D, the frame clip portion 60 includes a joint arm 62, a bridge 64, and a retaining arm 66 that together form a generally U-shaped channel 70. The joint arm 62 fits within the space between the joint flange 50 and the inner arm 44 of the windshield clip portion 40 (the nub 52 helps to secure the joint arm 62 in place). The bridge 64 merges with one end of the joint arm 62 and extends therefrom away from the inner arm 42; in some embodiments, the bridge 64 forms an acute angle (typically between about 70 and 85 degrees) with the joint arm 62. The retaining arm 66 extends away from the bridge 64. In the illustrated embodiment, the retaining arm 66 forms an acute angle with the bridge 64 (this angle may be between about 70 and 85 degrees). An extension 68 projects away from the fixed end of the retaining arm 64 generally coplanar with the bridge 64.

The frame clip portion 60 is typically formed of an elastomeric material that allows for flexibility and bending sufficient to enable the retaining clip 10 to grasp and release the upright posts 21 of the frame 17 in the manner described below. Typically the frame clip portion 60 is formed of a material that is considerably less rigid than the material of the windshield clip portion 40. Exemplary materials include rubbers like styrene-butadiene copolymer, polychloroprene (neoprene), nitrile rubber, butyl rubber, cis-1-4-polyisoprene, ethylene-propylene terpolymer (EPDM rubber), silicone rubber, polyurethane rubber, thermoplastic elastomers such as SANTOPRENE™ elastomers (available from ExxonMobil Chemical, Akron, Ohio), vinyl and like materials. In some embodiments, the frame clip portion 60 may be provided with an ultraviolet inhibitor in the material to protect the frame clip portion 60 from damage caused by exposure to sunlight.

Referring now to FIGS. 3A and 3B, the retaining clip 10 can secured to the upper panel 31 of the windshield assembly 30 by sliding the windshield clip portion 40 onto a side edge of the upper panel 31 such that the side edge of the upper panel 31 fits within the channel 45. The tapered shape of the channel 45 can require the outer and/or inner arms 42, 44 to deflect in order to receive the upper panel 31; as such, the outer and inner arms 42, 44 apply a spring force to the upper panel 31 that assists in securing the upper panel 31 in place. The fingers 48 provide some cushioning to the upper panel 31. In some embodiments, the side edge of the upper panel 31 may include a notch (not shown) sized to receive the bridge 46 of the windshield clip portion 40 to assist in locating the retaining clip 10 in a desired location on the upper panel 31. The configuration of the windshield clip portion 40 allows it to be attached and removed easily from the upper panel 31 in the event that the retaining clip 10 becomes damaged or needs to be replaced.

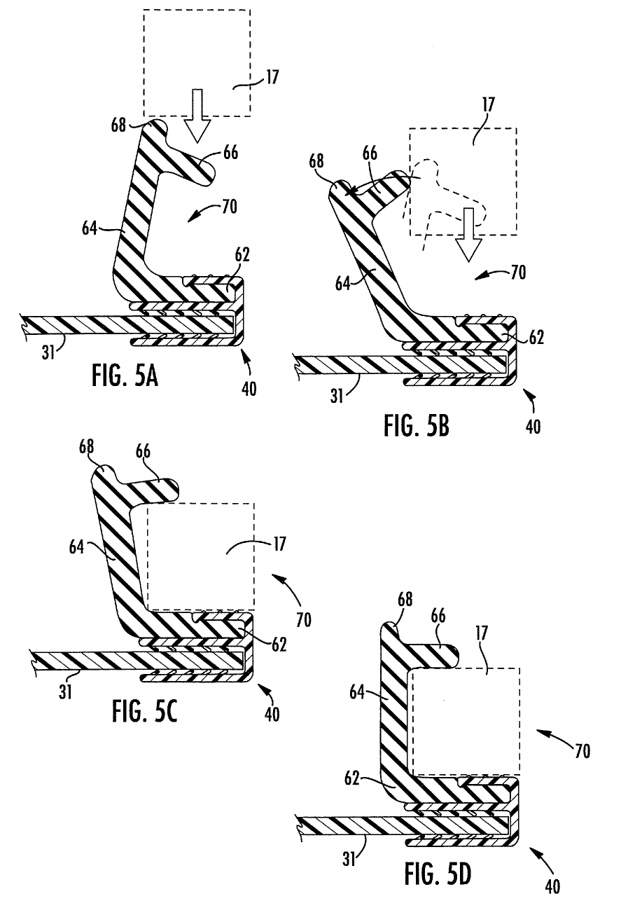

Once the retaining clip 10 has been applied to the windshield 30, the retaining clip 10 can be employed to retain the upper panel 31 in the closed position by clipping itself to the frame 17. As shown in FIGS. 5A-5D, the channel 70 of the frame clip portion 60 can be opened by deflecting the retaining arm 66 away from the joint arm 62 (FIG. 5B). This movement can be facilitated by gripping the retaining clip portion 60 by the extension 68. Once the retaining arm 66 has been sufficiently deflected, the retaining clip 10 (and, in turn, the upper panel 31) can be moved adjacent the frame 17 until the joint arm 62 is positioned against the front support post 21. The retaining arm 66 can then be released (FIG. 5C); it will recover toward its relaxed position until either or both of the bridge 64 and the retaining arm 66 contact the front support post 21 (so that the front support post 21 is captured within the channel 70). In this position, the retaining arm secures the upper panel 31 of the windshield assembly 30 to the front support post 21, thereby retaining the upper panel 31 in its open position.

With the upper panel 31 firmly secured within the cavity 70 of the retaining clip 10, the retaining clip 10 can reduce vibrational forces and shear stress on the upper windshield panel 31 as no bolts or other fasteners are put through the plane of the upper windshield panel 31.

In some embodiments, the retaining clip 10 can be formed largely via a single co-extrusion process. In such a process, PVC or another polymer is extruded through a first portion of an extrusion die to form the windshield clip portion 40, and polyurethane rubber or another elastomer is extruded thorough a second portion of the extrusion die to form the retaining clip portion 60. In embodiments that include the fingers 48 and/or the rub strips 54, these structures may also be formed in the co-extrusion process by extruding a third material, such as flexible PVC, through a third portion of the extrusion die. The materials are permitted to freeze upon exiting the die. The co-extruded blank can then be sliced to a desirable length (typically between about 1.0 and 3.0 inches) to form the retaining clip 10.

In some embodiments, the retaining clip 10 may include a windshield engaging portion that is attached in some manner other than with a windshield clip portion; for example, the windshield engaging portion may include a slot for adhesive attachment, a hook that engages an opening in the windshield, or the like. Other alternatives may also be suitable for use in the retaining clip.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A retaining clip for the windshield of a wheeled vehicle, comprising:
a windshield clip portion formed of a first material, the windshield clip portion including an inner wall, an outer wall, and a bridge connecting ends of the inner and outer walls to form a windshield clip channel sized to receive a side edge of a windshield panel; and
a frame clip portion formed of a second material that differs from the first material, the frame clip portion including a joint arm mounted to the windshield clip inner wall, a retaining arm, and a bridge connecting ends of the joint arm and the retaining arm to form a frame clip channel.

2. The retaining clip defined in claim 1, wherein the windshield clip portion includes a joint flange that overlies a portion of the joint arm of the frame clip portion.

3. The retaining clip defined in claim 1, wherein the first material is a polymeric material, and the second material is an elastomeric material.

4. The retaining clip defined in claim 1, wherein the frame clip portion includes an extension that extends from a junction between the bridge and the retaining arm.

5. The retaining clip defined in claim 1, wherein the frame clip portion and the windshield clip portion are co-extruded.

6. The retaining clip defined in claim 1, wherein the windshield clip portion includes a plurality of fingers that extend into the windshield clip channel from at least one of the inner arm and the outer arm.

7. The retaining clip defined in claim 6, wherein the fingers are formed of a third material that differs from the second material.

8. The retaining clip defined in claim 7, wherein the frame clip portion, the windshield clip portion, and the fingers are co-extruded.

9. The retaining clip defined in claim 2, wherein the windshield clip portion includes a rub strip on the joint flange.

10. The retaining clip defined in claim 9, wherein the rub strip is formed of a third material that is different than the first and second materials.

11. A windshield assembly for a wheeled vehicle, comprising:
a windshield panel having a side edge; and
a retaining clip comprising:
a windshield engaging portion formed of a first material, the windshield engaging portion engaging the side edge of the windshield panel; and
a frame clip portion formed of a second material that differs from the first material, the frame clip portion including a joint arm mounted to the windshield engaging portion, a retaining arm, and a bridge connecting ends of the joint arm and the retaining arm to form a frame clip channel.

12. The windshield assembly defined in claim 11, wherein the windshield engaging portion comprises a windshield clip portion having an outer arm, an inner arm, and a bridge connecting ends of the outer and inner arm to form a windshield clip channel, and wherein the side edge of the windshield is received in the windshield clip channel.

13. The windshield assembly defined in claim 12, wherein the windshield clip portion includes a joint flange that overlies a portion of the joint arm of the frame clip portion.

14. The windshield assembly defined in claim 11, wherein the first material is a polymeric material, and the second material is an elastomeric material.

15. The windshield assembly defined in claim 11, wherein the frame clip portion includes an extension that extends from a junction between the bridge and the retaining arm.

16. The windshield assembly defined in claim 11, wherein the frame clip portion and the windshield engaging portion are co-extruded.

17. The windshield assembly defined in claim 12, wherein the windshield clip portion includes a plurality of fingers that extend into the windshield clip channel from at least one of the inner arm and the outer arm.

18. The windshield assembly defined in claim 17, wherein the fingers are formed of a third material that differs from the second material.

19. The windshield assembly defined in claim 8, wherein the frame clip portion, the windshield clip portion, and the fingers are co-extruded.

20. The windshield assembly defined in claim 13, wherein the windshield clip portion includes a rub strip on the joint flange.

21. A method of forming a retaining clip for a windshield assembly, comprising the steps of:
providing an extrusion die having a first portion and a second portion;
extruding a first polymeric material through a first portion of the extrusion die, the first portion of the extrusion die forming the first material into a windshield engaging portion;
extruding a second elastomeric material through the second portion of the die, the second material being different than the first material, the second portion of the die forming the second material into a frame clip portion having a joint arm in contact with the windshield engaging portion, a retaining arm, and a bridge connecting ends of the joint arm and the retaining arm to form a frame clip channel; and
allowing the first and second materials to freeze to form a retaining clip.

22. The method defined in claim 21, wherein the windshield engaging portion comprises a windshield clip portion having an outer arm, an inner arm, and a bridge connecting ends of the outer and inner arm, the outer and inner arms and the bridge forming a windshield clip channel that is configured to engage a windshield.

23. The method defined in claim 22, further comprising the step of extruding a third material through a third portion of the extrusion die, the third material being different from the first and second materials, the third portion of the extrusion die forming the third material into a plurality of fingers extending into the windshield clip channel from at least one of the inner arm and the outer arm and
allowing the third material to freeze.

24. The method defined in claim 21, wherein the first material comprises rigid PVC.

25. The method defined in claim 24, wherein the second material comprises rubber.

26. The method defined in claim 23, wherein the third material comprises flex PVC.
